(19) United States
(12) Patent Application Publication
(10) Pub. No.: US 2016/0275046 A1
(43) Pub. Date: Sep. 22, 2016

(54) METHOD AND SYSTEM FOR PERSONALIZED PRESENTATION OF CONTENT

(71) Applicant: Yahoo! Inc., Sunnyvale, CA (US)

(72) Inventors: Hao Zheng, Beijing (CN); Hai Yu, Beijing (CN); Hanwen Yang, Beijing (CN)

(21) Appl. No.: 14/399,331

(22) PCT Filed: Jul. 8, 2014
(86) PCT No.: PCT/CN2014/081853

§ 371 Date: Nov. 6, 2014

(51) Int. Cl. G06F 17/21; H04L 29/08

(52) U.S. Cl. CPC G06F 17/211; H04L 67/22; H04L 67/306

(57) ABSTRACT

Methods, systems and programming for personalized presentation of content are presented. In one example, a first reference to a first content item is provided to a user. An input is received from the user indicating that the user is following the first reference to access the first content item. A likelihood is calculated, where the likelihood represents how likely the user will be interested in an additional content item similar to the first content item. An actionable representation of the additional content item is provided to the user. The actionable representation comprises an additional reference to the additional content item. The actionable representation is presented in a manner determined based on the calculated likelihood.

### TECHNICAL FIELD

The present teaching relates to methods, systems and programming for content presentation to a user. Particularly, the present teaching is directed to methods, systems, and programming for personalized content presentation based on a user's interest in a particular topic.

### BACKGROUND

The amount of information a person can access without much effort through the Internet can be overwhelming. Too much information can impede cognition and decision making, just like too little information can. The overwhelming amount of information tends to shorten the attention span to a particular piece of information because the cognitive power of a person did not significantly increase with the amount of accessible information the Internet made available. One effect of the shorter attention span is that a person tends to be more easily distracted. From the perspective of an Internet content provider, the distraction may be that a competitor draws away a person's attention. Therefore, selectively presenting content that is appealing to a person helps to retain the person's attention and gain a competitive edge.

Content presented in a browser or an app may be organized in a content stream. A content stream is a popular format especially for news, threads of discussion in online forums, and search results from a search engine. FIG. 1 (Prior Art) illustrates a typical content stream. References to a series of content items (e.g., titles 110 of a series of articles as hyperlinks) are presented as a list. Some or all of the references 110 are followed by snippets 120 selected from or generated based on the content. A thumbnail picture 130 may also be presented adjacent to some or all of the references. The references are usually actionable representations, i.e., a representation that allows user interaction therewith.

The organization within a content stream (e.g., the titles and snippets in FIG. 1) may impact the user's experience. FIG. 2 (Prior Art) illustrates an organization of references to content items in a content stream, where references to content items on the same subject are presented spatially close to one another. In FIG. 2, three references 202, 204, 206 to articles on the same subject (Subject A) are next to one another and a reference 210 to an article on a different subject (Subject X) is presented away from the three references 202, 204, 206 to articles on Subject A. In this organization, if a user is indeed interested in that subject, he may easily access many content items on that subject due to the close spatial proximity of the references thereto. However, if a user is not interested in that subject, he is likely to navigate away from the content stream. Even if a user is interested, boredom may quickly set in. Another issue of this organization is that the content items on the same subject may occupy much of the available space on the display and do not leave enough space for references to content items on other subjects.

FIG. 3 (Prior Art) illustrates another organization of references to content items in a content stream, where references to content items on the same subject are spaced away from one another and references to content items of different subjects are presented spatially close to one another. In FIG. 3, there are three references next to one another: a first reference 302 to an article on Subject A, a reference 312 to an article on Subject B and a reference 322 to an article on Subject C. A second reference 304 to another article on Subject A is presented away from the first reference 302. In this organization, a user may find some of the different subjects to be of interest. However, if the user wants to find additional content items on subject A, he would have to move further down the content stream or navigate away from the content stream.

While what is appealing varies from one user to another, existing techniques failed to take into consideration characteristics of the user to whom the content is selected to be presented. In addition, traditional systems for presenting content to a user did not provide a way to ascertain characteristics of the user or establish a link between the user's characteristics and what appeals to her.

Therefore, there is a need to provide a solution for personalized content presentation to avoid the above-mentioned drawbacks.

### SUMMARY

The teachings disclosed herein relate to methods, systems, and programming for content presentation to a user. More particularly, the present teaching relates to methods, systems, and programming for personalized content presentation based on a user's interest in a particular topic.

In one example, a method, implemented on a machine having at least one processor, storage, and a communication platform connected to a network for personalized presentation of content is provided. A first reference to a first content item is provided to a user. An input is received from the user indicating that the user is following the first reference to access the first content item. A likelihood is calculated, where the likelihood represents how likely the user will be interested in an additional content item similar to the first content item. An actionable representation of the additional content item is provided to the user. The actionable representation comprises an additional reference to the additional content item. The actionable representation is presented in a manner determined based on the calculated likelihood.

In another example, a system having at least one processor, storage, and a communication platform connected to a network for personalized presentation of content is provided. The system comprises a presentation personalization unit, a user activity detection unit, and a topic exploration likelihood calculator. The presentation personalization unit is configured to provide, to a user, a first reference to a first content item. The user activity detection unit is configured to receive an input from the user indicating that the user is following the first reference to access the first content item. The topic exploration likelihood calculator is configured to calculate a likelihood that the user will be interested in an additional content item similar to the first content item. The presentation personalization unit is further configured to provide, to the user, an actionable representation of the additional content item. The actionable representation comprises an additional reference to the additional content item. The actionable representation is presented in a manner determined based on the calculated likelihood.

Other concepts relate to software for personalized presentation of content. A software product, in accord with this concept, includes at least one non-transitory machine-readable medium and information carried by the medium. The information carried by the medium may be executable program code data regarding parameters in association with a request or operational parameters, such as information related to a user, a request, or a social group, etc.

In one example, a non-transitory machine readable medium having information recorded thereon for personalized presentation of content is provided. The recorded information, when read by the machine, causes the machine to perform the following. A first reference to a first content item is provided to a user. An input is received from the user indicating that the user is following the first reference to access the first content item. A likelihood is calculated, where the likelihood represents how likely the user will be interested in an additional content item similar to the first content item. An actionable representation of the additional content item is provided to the user. The actionable representation comprises an additional reference to the additional content item. The actionable representation is presented in a manner determined based on the calculated likelihood.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 illustrates a typical content stream;

FIG. 2 illustrates an organization of references to content items in a content stream;

FIG. 3 illustrates another organization of references to content items in a content stream;

FIGS. 4-5 illustrate an exemplary organization of references to content items in a content stream, according to an embodiment of the present teaching;

FIG. 6 illustrates another exemplary organization of references to content items in a content stream, according to an embodiment of the present teaching;

FIG. 7 is a high level depiction of an exemplary networked environment for personalized content presentation, according to an embodiment of the present teaching;

FIG. 8 is a high level depiction of another exemplary networked environment for personalized content presentation, according to an embodiment of the present teaching;

FIG. 9 illustrates an exemplary diagram of a page personalization engine for personalized content presentation, according to an embodiment of the present teaching;

FIG. 10 is a flowchart of an exemplary process performed by a page personalization engine, according to an embodiment of the present teaching;

FIG. 11 illustrates an exemplary diagram of a user activity detection unit in a page personalization engine, according to an embodiment of the present teaching;

FIG. 12 is a flowchart of an exemplary process performed by a user activity detection unit, according to an embodiment of the present teaching;

FIG. 13 illustrates an exemplary diagram of a content item presentation personalization controller in a page personalization engine, according to an embodiment of the present teaching;

FIG. 14 is a flowchart of an exemplary process performed by a content item presentation personalization controller, according to an embodiment of the present teaching;

FIG. 15 illustrates an exemplary diagram of a topic exploration likelihood estimation unit in a page personalization engine, according to an embodiment of the present teaching;

FIG. 16 is a flowchart of an exemplary process performed by a topic exploration likelihood estimation unit, according to an embodiment of the present teaching;

FIG. 17 illustrates an exemplary diagram of a page personalization unit in a page personalization engine, according to an embodiment of the present teaching;

FIG. 18 is a flowchart of an exemplary process performed by a page personalization unit, according to an embodiment of the present teaching;

FIG. 19 depicts a general mobile device architecture on which the present teaching can be implemented; and

FIG. 20 depicts a general computer architecture on which the present teaching can be implemented.

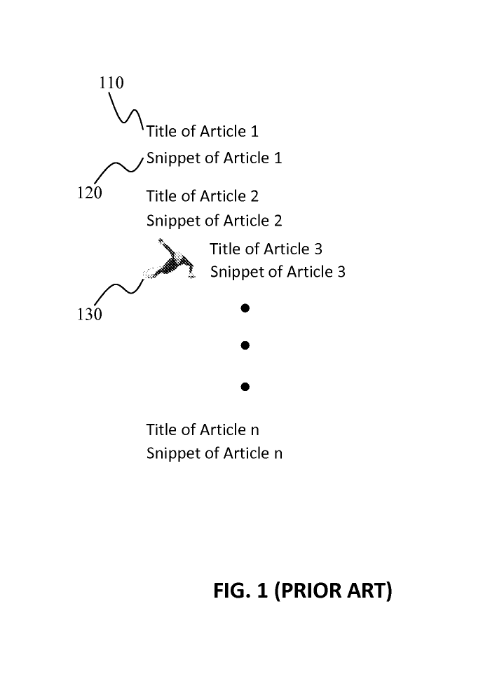

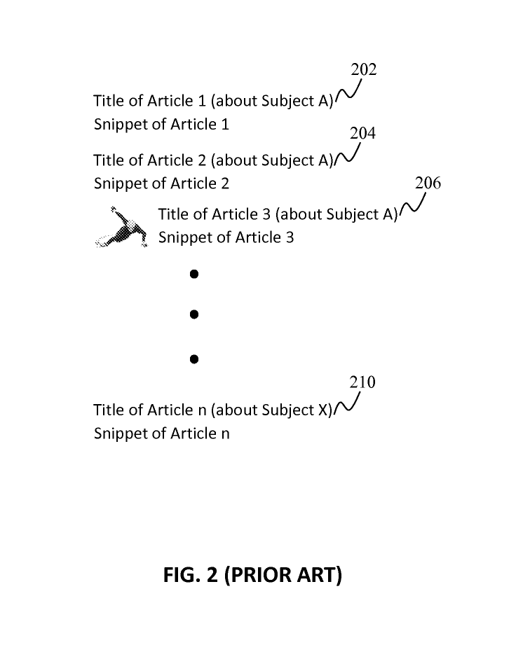

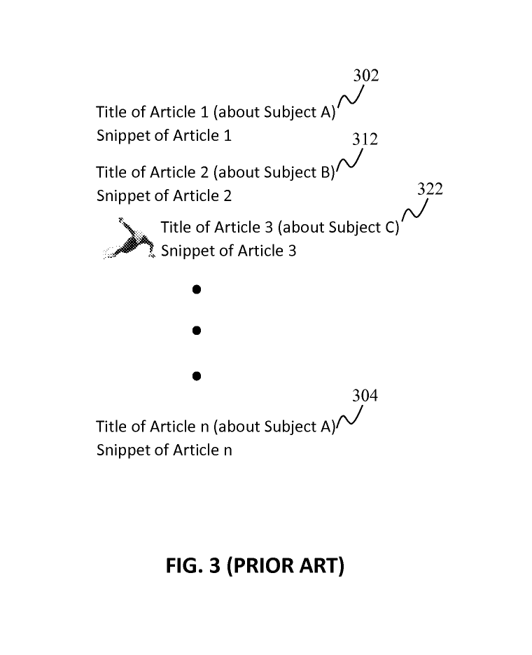

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The present disclosure describes method, system, and programming aspects of effective and selective personalized content presentation. Selectively presenting content is especially beneficial to both an Internet content provider and the user who receives the content, in the era of mobile devices. Mobile devices, due to their smaller sizes, have limited amount of space available on a display. Content that is more likely to appeal to the recipient thus should be given more of the limited space to improve the experience of the use and discourage distraction.

According to various embodiments of the present teaching, a method of personalized presentation of content items may be used to overcome the issues associated with conventional organizations of a content stream. For example, if it has been determined that after a particular user follows a first reference to first content item on a subject, she is likely to follow additional references to additional content items on that subject, then these additional references may be presented as a collapsible group adjacent to the first reference. The additional references may not be presented if the user did not follow the first reference or if the user is not likely to follow the additional references.

The likelihood for the user to follow the additional references may be determined based on characteristics of the user, which includes but not limited to: information from a user profile of the user, location information of the user, and the user's engagement with respect to the first content item. The likelihood may also be determined based on social interest related to the first content item and news related to the first content item. The collapsible group may be presented in either an expanded form or a condensed form, depending on the likelihood that the user is predicted to follow the additional references.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

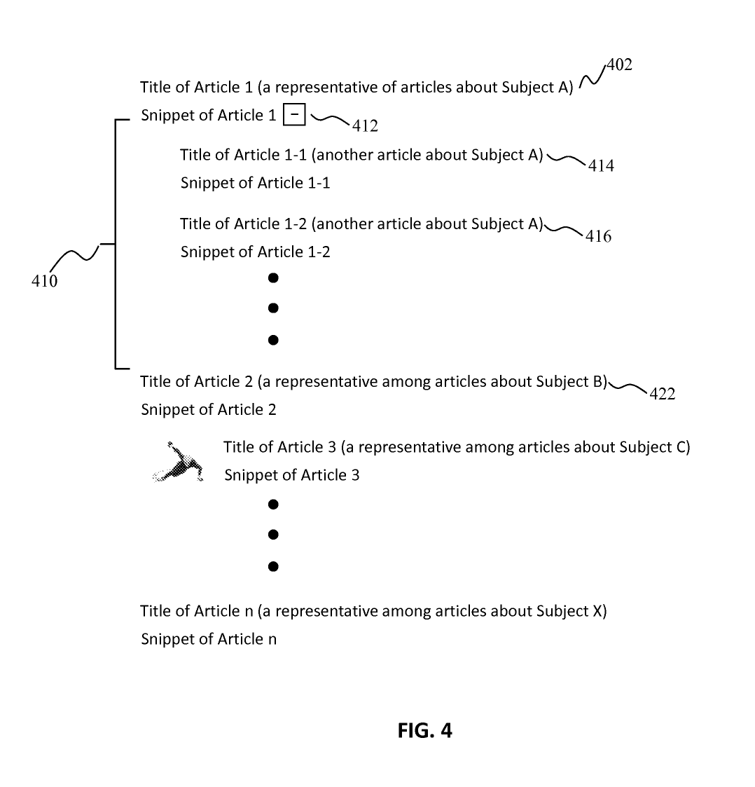

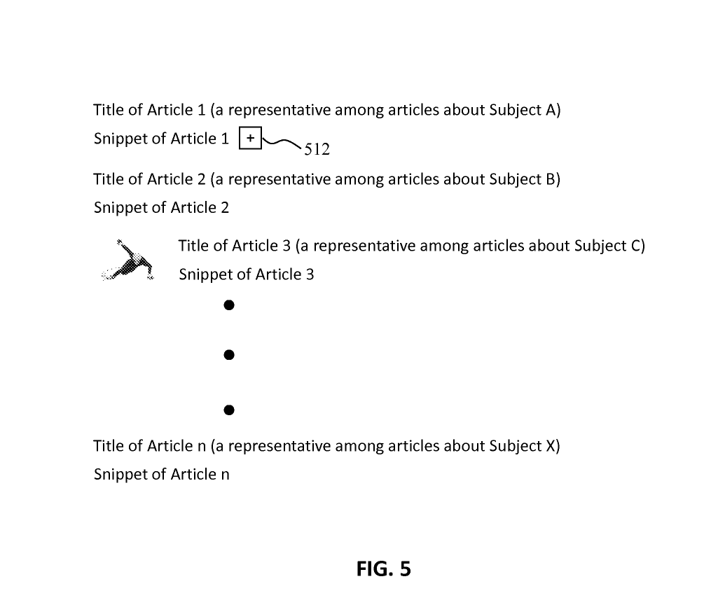

FIGS. 4-5 illustrate an exemplary organization of references to content items in a content stream, according to an embodiment of the present teaching. As illustrated in FIG. 4, a collapsible group 410 may include an actionable representation 422 following the first reference 402 and the additional references 414, 416 to the additional content items. In one example, the actionable representation may be a symbol “[+]” 512 as shown in FIG. 5, that when clicked, becomes a symbol “[−]” and causes the collapsible group to change from a condensed form to an expanded form, thereby showing the references to the additional content items. In another example, the actionable representation may be the symbol “[−]” 412 as shown in FIG. 4, that when clicked, becomes the symbol “[+]” and causes the collapsible group to change from the expanded form to the condensed form, thereby hiding the references to the additional content items.

Thus, the collapsible group may be presented in the expanded form as shown in FIG. 4 or in the condensed form as shown in FIG. 5. According to an embodiment, when it has been determined that a particular user is more likely to follow one of the additional references (e.g., references 414, 416 to Articles 1-1, 1-2, both on Subject A) than to follow a reference following the collapsible group (usually to content on a different subject, e.g., reference 422 to Article 2, on Subject B), the collapsible group is presented in the expanded form as shown in FIG. 4; when it has been determined that a particular user is not more likely to follow one of the additional references than to follow a reference following the collapsible group, the collapsible group is presented in the condensed form as shown in FIG. 5.

It can be understood by one skilled in the art that the content stream in the present teaching is not limited to one-dimensional lists. For example, the titles in FIG. 4 may also be presented in a two-dimensional grid. The term “content” in the present teaching may include but is not limited to a news story, a webpage, a file hosted on a server. The references in the present teaching may be actionable representations, i.e., a representation that allows user interaction therewith. A content item in the present teaching may be a piece of content referred in a web page. It can be understood that a content item in a page may include a reference in the page linking to content outside the page. In the present teaching, a content item related to a topic may include a reference to some content related to a topic.

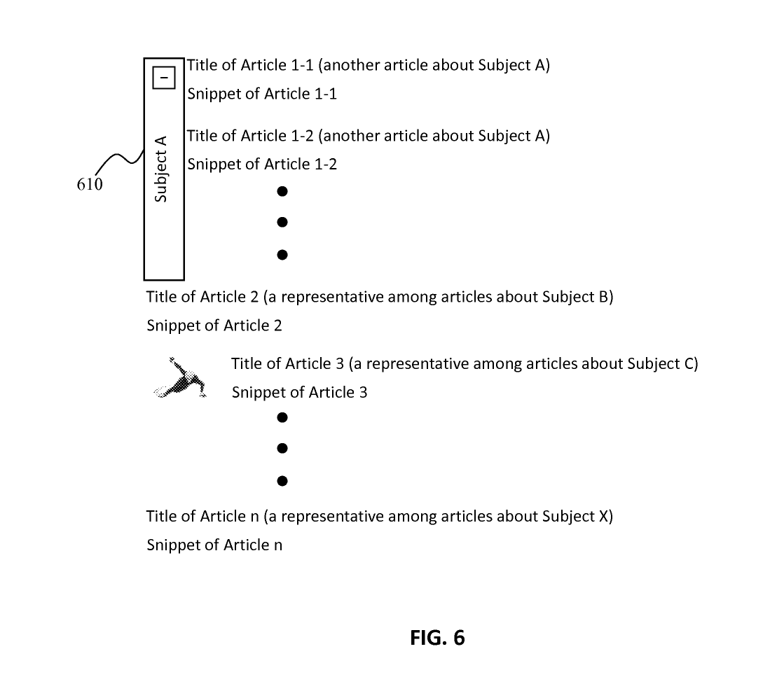

FIG. 6 illustrates another exemplary organization of references to content items in a content stream, according to an embodiment of the present teaching. As illustrated in FIG. 6, a collapsible group may include an actionable representation as a sidebar 610 spanning the first reference and the additional referenced if presented. In one example, the actionable representation may be a minus sign, which hides the additional references when clicked. In another example, the actionable representation may be a plus sign, which presents the additional references when clicked.

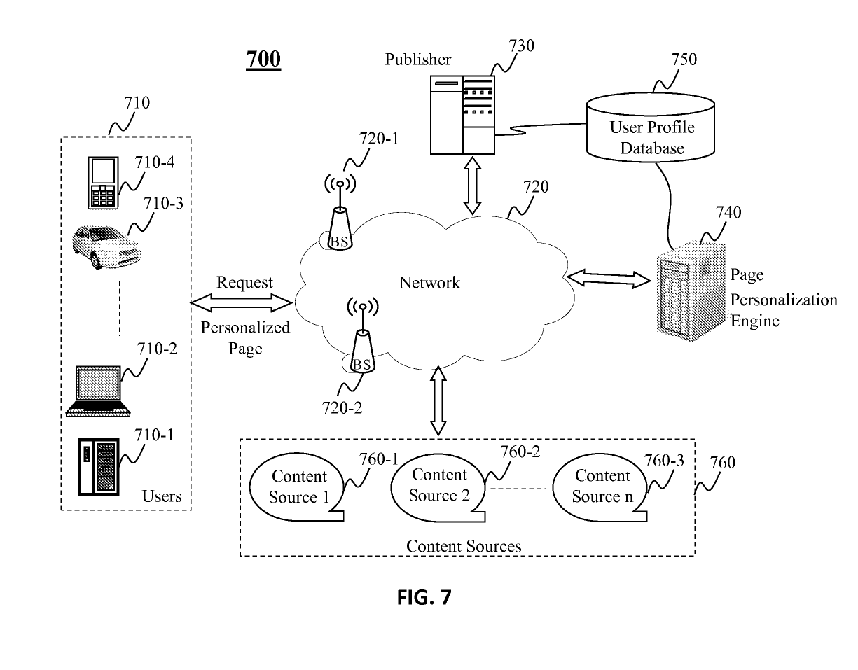

FIG. 7 is a high level depiction of an exemplary networked environment 700 for personalized content presentation, according to an embodiment of the present teaching. In FIG. 7, the exemplary networked environment 700 includes a publisher 730, a page personalization engine 740, a user profile database 750, one or more users 710, a network 720, and content sources 760. The network 720 may be a single network or a combination of different networks. For example, the network 720 may be a local area network (LAN), a wide area network (WAN), a public network, a private network, a proprietary network, a Public Telephone Switched Network (PSTN), the Internet, a wireless network, a virtual network, or any combination thereof. In an example of Internet advertising, the network 720 may be an online advertising network or ad network that is a company connecting advertisers to web sites that want to host advertisements. A key function of an ad network is aggregation of ad space supply from publishers and matching it with advertiser demand. The network 720 may also include various network access points, e.g., wired or wireless access points such as base stations or Internet exchange points 720-1 . . . 720-2, through which a data source may connect to the network 720 in order to transmit information via the network 720.

Users 710 may be of different types such as users connected to the network 720 via desktop computers 710-1, laptop computers 710-2, a built-in device in a motor vehicle 710-3, or a mobile device 710-4. A user 710 may send a request to the publisher 730 via the network 720 and receive a response to the request from the publisher 730. The response may include a personalized page and/or personalized content items related to the request.

The page personalization engine 740 can help the publisher 730 to generate the personalized page, based on the user's characteristics and/or historical interest(s). In this embodiment, the page personalization engine 740 directly connects to the network 720 and can communicate with the users 710 directly via the network 720.

The page personalization engine 740 can retrieve a user profile of the user from the user profile database 750. The user profile database 750 stores user profiles for different users of the publisher 730 and/or the page personalization engine 740. Each of the stored user profiles may include information related to a user, including but not limited to: demographic information of the user, historical behaviors of the user.

The content sources 760 include multiple content sources 760-1, 760-2 . . . 760-3, such as vertical content sources. A content item source 760 may correspond to a website hosted by an entity, whether an individual, a business, or an organization such as USPTO.gov, a content item provider such as cnn.com and Yahoo.com, a social network website such as Facebook.com, or a content feed source such as tweeter or blogs. The publisher 730 and the page personalization engine 740 may access information from any of the content sources 760-1, 760-2 . . . 760-3. For example, the publisher 730 may fetch content, e.g., websites, through its web crawler to build a web page.

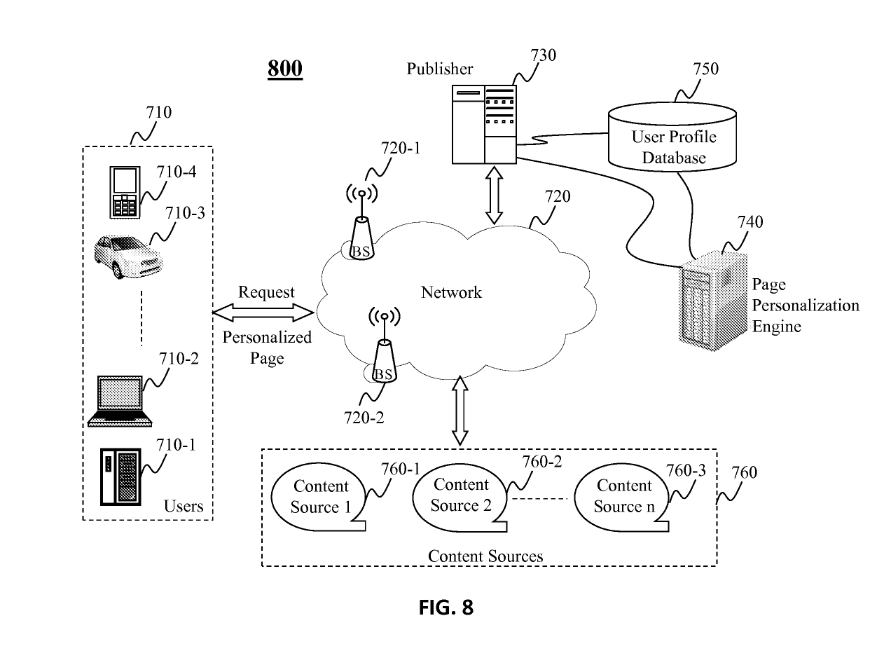

FIG. 8 is a high level depiction of another exemplary networked environment 800 for personalized content presentation, according to an embodiment of the present teaching. The exemplary networked environment 800 in this embodiment is similar to the exemplary networked environment 700 in FIG. 7, except that the page personalization engine 740 in this embodiment connects to the network 720 via the publisher 730. For example, the page personalization engine 740 may serve as a backend of the publisher 730 to perform personalization for a web page to be presented to a user communicating with the publisher 730.

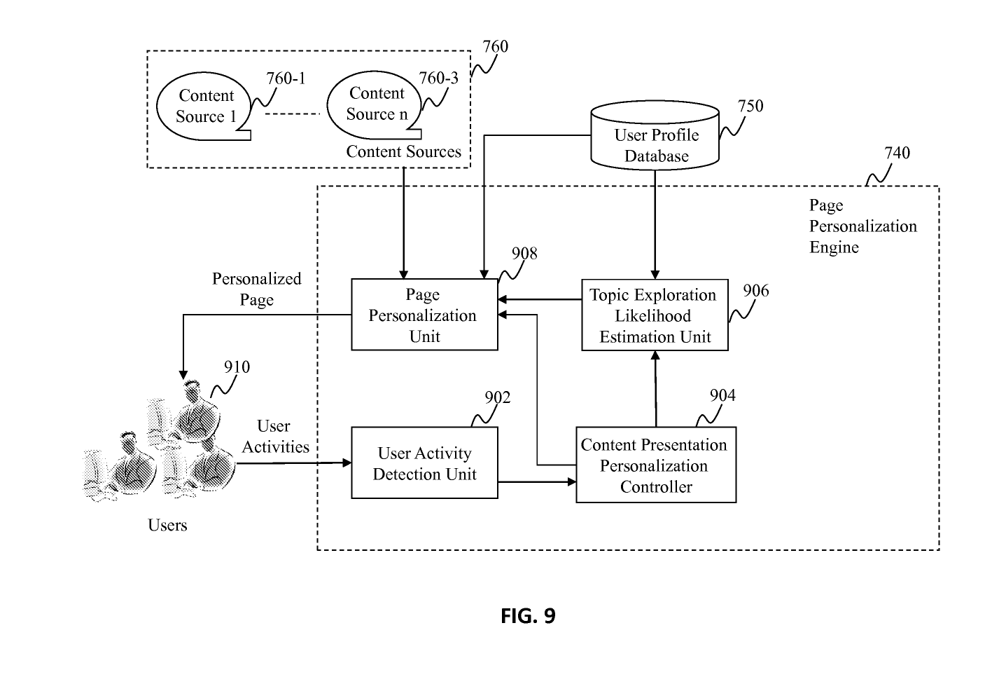

FIG. 9 illustrates an exemplary diagram of a page personalization engine 740 for personalized content presentation, according to an embodiment of the present teaching. The page personalization engine 740 may be in an exemplary networked environment, e.g., the networked environment 700 in FIG. 7 or the networked environment 800 in FIG. 8. The page personalization engine 740 in this example includes a user activity detection unit 902, a content presentation personalization controller 904, a topic exploration likelihood estimation unit 906, and a page personalization unit 908. The page personalization engine 740 in this example receives inputs from users 910 and generates a personalized page to be provided to the users 910. In some embodiments, the personalized page may be provided to the users 910 via the publisher 730, or provided to the users 910 directly as shown in FIG. 9.

The user activity detection unit 902 in this example may monitor user activities from different users. The user activities may include either an action or inaction from a user. An action from a user may include pressing, swiping, clicking, rotating, zooming, scrolling, etc. An example of inaction from a user may be a dwell time within which the user does not provide any input. In addition to traditional user activities like mouse clicking or keyboard typing related to links to search results provided to a user, more user activities related to manipulation of a content item provided to a user can be detected and utilized for generating a personalized content presentation.

In one situation, a user is presented with a page including a first reference to a first content item and optionally a second reference to a second content item. The second content item may be on a different subject from the first content item. The first and second references may be arranged spatially adjacent to each other. The user activity detection unit 902 may detect an activity from the user, where the activity represents that the user desires to access the first content item by following the first reference to navigate away from the original page. The user activity detection unit 902 may also detect activities from the user during her access to the first content item and an activity representing a request to come back to the original page. The user activity detection unit 902 may then send to the content presentation personalization controller 904 information related to the detected activities.

The first reference and the second reference may be hyperlinks or any other suitable actionable representations. The first and second content items may be in the form of a hypertext file, a script, a media file (e.g., audio, video), or any content that may be perceived by the user, through any suitable program or app.

The content presentation personalization controller 904 in this example determines that the user 910 has requested for a web page, e.g. after accessing a first content item the user sent a request to come back to the original page including the first reference to the first content item. In this situation, since the user 910 has accessed the first content item, it can be determined whether to provide more content items similar to the first content item in the page or not. This may be determined based on a likelihood that the user 910 will follow the more content items to be added. To calculate the likelihood, the content presentation personalization controller 904 may evaluate user engagement of the user during the access to the first content item, detect location information of the user, and obtain social interest, breaking news, and/or popular news related to the first content item. Based on the information detected or collected by the content presentation personalization controller 904, the content presentation personalization controller 904 can generate presentation control information. The content presentation personalization controller 904 may then send the presentation control information to the topic exploration likelihood estimation unit 906 for calculating the likelihood and to the page personalization unit 908 for generating a personalized page.

The topic exploration likelihood estimation unit 906 in this example retrieves a user profile of the user and calculates a topic exploration likelihood for the user based at least in part on the user profile. The topic exploration likelihood represents how likely the user 910 will follow additional content items related to the same topic as that of the first content item, if the additional content items are added to the page, i.e. if the topic is explored with the additional content items. The topic exploration likelihood estimation unit 906 may determine a topic or subject of the first content item, e.g. based on the presentation control information sent by the content presentation personalization controller 904.

The topic exploration likelihood estimation unit 906 may select or determine a likelihood calculation model to calculate the likelihood based on the topic and/or the presentation control information. For example, if the first content item is related to a hot topic drawing many social interests and there are many breaking news related to the topic, a model having more weights on the social interests and breaking news can be selected so that unless the user has shown explicit dislikes regarding the topic, more breaking news and more social interests lead to higher likelihood for the user to follow additional content items about the topic. For example, if the user has shown high engagement during her access to the first content item, e.g. by activities like frequent and active clicks, scrolls, zooms in, etc., another model may be selected so that even if the topic is not popular among social interests, the user is very likely to follow references to additional content items about the topic due to her engagement regarding the first content item related to the topic. In another example, a model can be selected based on the user's location. If the user is detected to be located in Hawaii, for example, after the user accessed a first content item related to Hawaii, there is a high likelihood for the user to follow additional references to additional content items related to Hawaii.

After the topic exploration likelihood is calculated, the topic exploration likelihood estimation unit 906 may send the topic exploration likelihood to the page personalization unit 908 for generating a personalized page based on the topic exploration likelihood. The page personalization unit 908 in this example generates a personalized page based on the topic exploration likelihood and one or more likelihood related thresholds. A likelihood related threshold may be determined based on a user interest level of the user 910 when the topic is not explored, i.e. there is no additional content item about the topic to be presented. The page personalization unit 908 may predict a user interest level without topic exploration based on the presentation control information sent by the content presentation personalization controller 904 and/or a user profile of the user 910. The page personalization unit 908 may then generate or update the likelihood related threshold(s) based on the prediction.

In one example, a first likelihood related threshold is 0.6, which means if the topic exploration likelihood is greater than 0.6, the topic of first content item is explored as an actionable representation in an expanded form during the personalized page presentation, because the likelihood is high enough to ascertain a click from the user 910 on one of the additional references about the topic. In another example, a second likelihood related threshold is 0.4, which means if the topic exploration likelihood is less than 0.4, the topic of first content item is not explored at all during the personalized page presentation, because the topic exploration likelihood is lower than another likelihood that the user 910 will follow a second reference to a second content item about a different topic. In case the topic exploration likelihood is between the first and second likelihood related thresholds, the topic of first content item may be explored as an actionable representation in a condensed form during the personalized page presentation so that the user 910 has an option to click the actionable representation to explore the topic herself.

Thus, based on comparisons between the topic exploration likelihood and the likelihood related thresholds, a page presentation mode can be determined. According to the page presentation mode, the page personalization unit 908 may generate a personalized page or personalized content items based on content items retrieved from the content sources 760. The personalized page can be either sent directly to the user 910 as shown in FIG. 9 or sent to the user 910 via the publisher 730 in other embodiments.

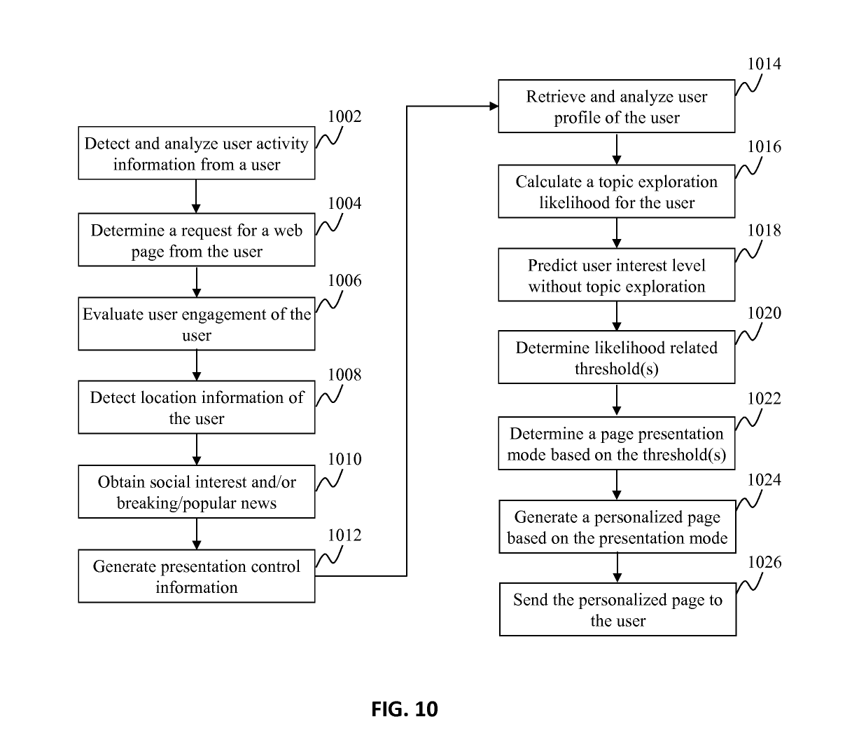

FIG. 10 is a flowchart of an exemplary process performed by a page personalization engine, according to an embodiment of the present teaching. In one example, the exemplary process in FIG. 10 may be performed by the page personalization engine 740 shown in FIG. 9. Starting at 1002, information related to user activities of a user is detected and analyzed. At 1004, a request for a web page is determined from the user, e.g. based on the detected and analyzed user activities. At 1006, user engagement of the user with respect to a first content item is evaluated. At 1008, location information of the user is detected. At 1010, social interest and/or breaking/popular news related to the first content item are obtained. At 1012, presentation control information is generated based on information obtained from 1006 to 1010. It can be understood by one skilled in the art that the process from 1006 to 1010 is optional and may be replaced by other process for collecting other information to generate the presentation control information.

At 1014, a user profile of the user is retrieved and analyzed. At 1016, a topic exploration likelihood is calculated for the user, e.g. based on the user profile. At 1018, a user interest level without topic exploration is predicted. At 1020, one or more likelihood related thresholds are determined, e.g. based on the predicted user interest level. At 1022, a page presentation mode is determined based on the one or more likelihood related thresholds and the calculated topic exploration likelihood, e.g. by comparing the topic exploration likelihood with the one or more likelihood related thresholds. At 1024, a personalized page is generated based on the presentation mode. The personalized page may be sent to the user at 1026, either directly or via the publisher 730.

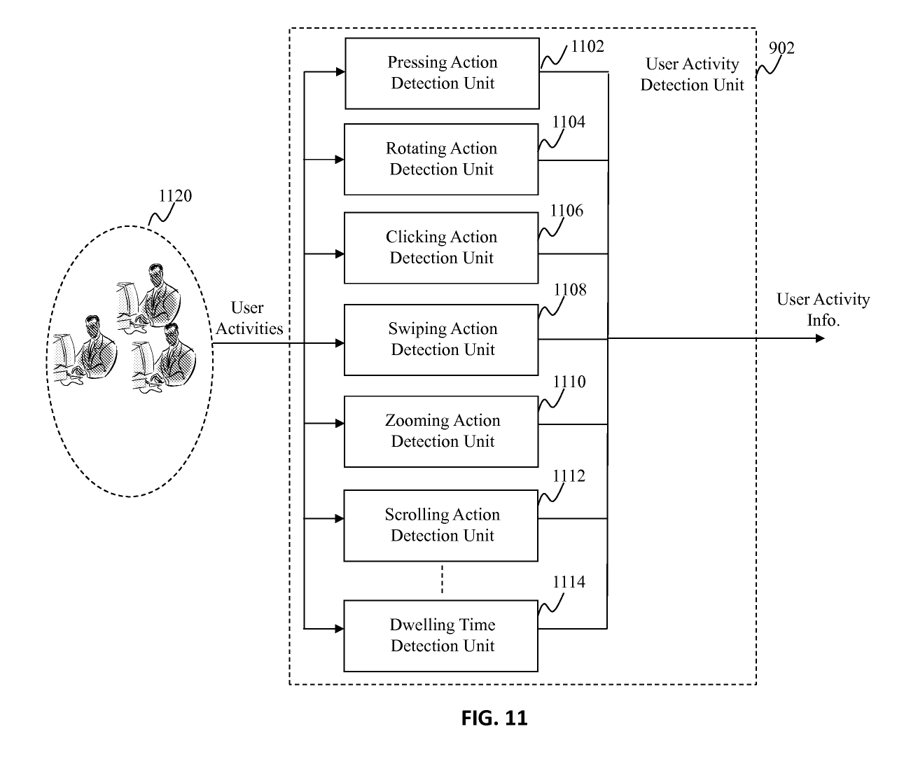

FIG. 11 illustrates an exemplary diagram of a user activity detection unit 902 in a page personalization engine, e.g. the page personalization engine 740 in FIG. 9, according to an embodiment of the present teaching. The user activity detection unit 902 in this example includes a pressing action detection unit 1102, a rotating action detection unit 1104, a clicking action detection unit 1106, a swiping action detection unit 1108, a zooming action detection unit 1110, a scrolling action detection unit 1112, and a dwelling time detection unit 1114. The pressing action detection unit 1102 may be configured for detecting a pressing action performed by a user 1120 on a touchscreen. For example, a pressing action can be detected when the user 1120 presses down on the touchscreen for a period of time longer than a predetermined threshold before the user 1120 releases the pressure. The rotating action detection unit 1104 may be configured for detecting a rotating action performed by a user 1120 on a touchscreen. For example, a rotating action can be detected when the user 1120 presses and rotates a content item on the touchscreen before the user 1120 releases the pressure. The clicking action detection unit 1106 may be configured for detecting a clicking action performed by a user 1120 on a touchscreen. For example, a clicking action can be detected when the user 1120 presses down on the touchscreen for a period of time shorter than a predetermined threshold before the user 1120 releases the pressure. The swiping action detection unit 1108 may be configured for detecting a swiping action performed by a user 1120 on a touchscreen. For example, a swiping action can be detected when the user 1120 presses down with a finger on the touchscreen and moves the finger on the surface of the touchscreen. The zooming action detection unit 1110 may be configured for detecting a zooming action performed by a user 1120 on a touchscreen. For example, a zooming action can be detected when the user 1120 presses down with more than one finger at the same time on the touchscreen and swipes with at least one finger. The scrolling action detection unit 1112 may be configured for detecting a scrolling action performed by a user 1120. For example, a scrolling action can be detected when the user 1120 moves or scrolls a scroll wheel on a computer mouse, a scrollable button on a laptop or smartphone, or a virtual scrollable icon on a touchscreen. The dwelling time detection unit 1114 may be configured for detecting a dwell time of the user 1120 when none of the other detection units in the user activity detection unit 902 detects any input from the user 1120 for a period of time.

It can be understood that other user activities can be determined based on user actions or inactions described above. For example, typing on the touchscreen can be detected when the user 1120 is clicking on a corresponding zone on the touchscreen. It can also be understood that more units related to user actions and/or inactions can be included in the user activity detection unit 902, e.g., units for detecting keyboard inputs and/or mouse inputs when the user 1120 is using a desktop or laptop.

Each detection unit in the user activity detection unit 902 may detect a user activity within a detection period. The user activity detection unit 902 may send to the content presentation personalization controller 904 user activity information including information related to detected user activities.

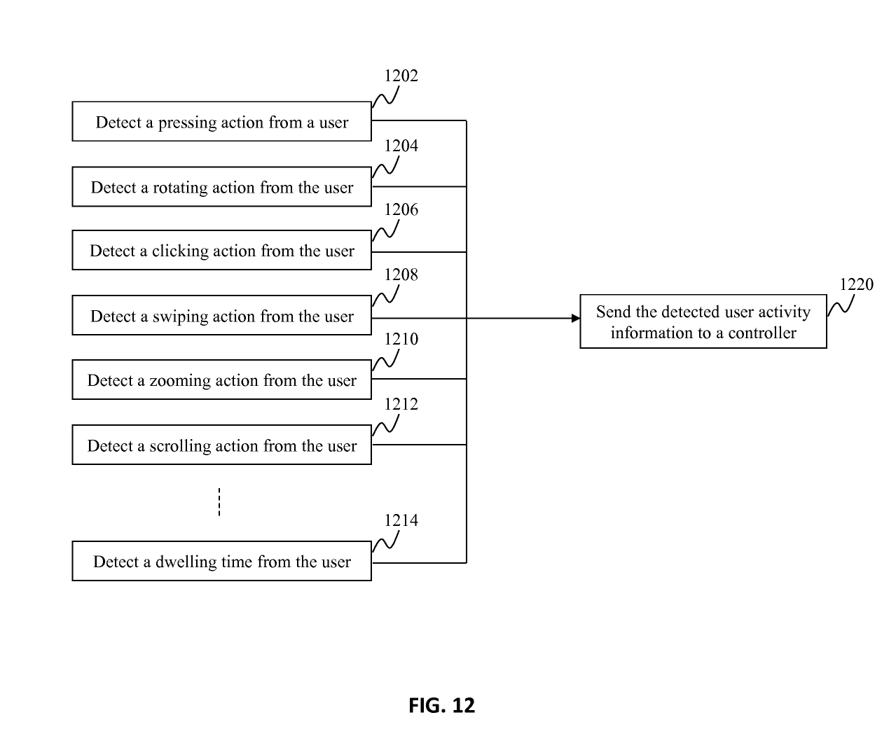

FIG. 12 is a flowchart of an exemplary process performed by a user activity detection unit, e.g. the user activity detection unit 902 in FIG. 11, according to an embodiment of the present teaching. At 1202, a pressing action is detected from a user. At 1204, a rotating action is detected from the user. At 1206, a clicking action is detected from the user. At 1208, a swiping action is detected from the user. At 1210, a zooming action is detected from the user. At 1212, a scrolling action is detected from the user. At 1214, a dwelling time is detected from the user. The processes 1202-1214 may be performed either in parallel as shown in FIG. 12 or in serial as in other embodiments. It can be understood that in some embodiments, only one or more of the processes 1202-1214 happen, and the process moves to 1220, where information related to the detected user activities is sent to a controller, e.g. the content presentation personalization controller 904.

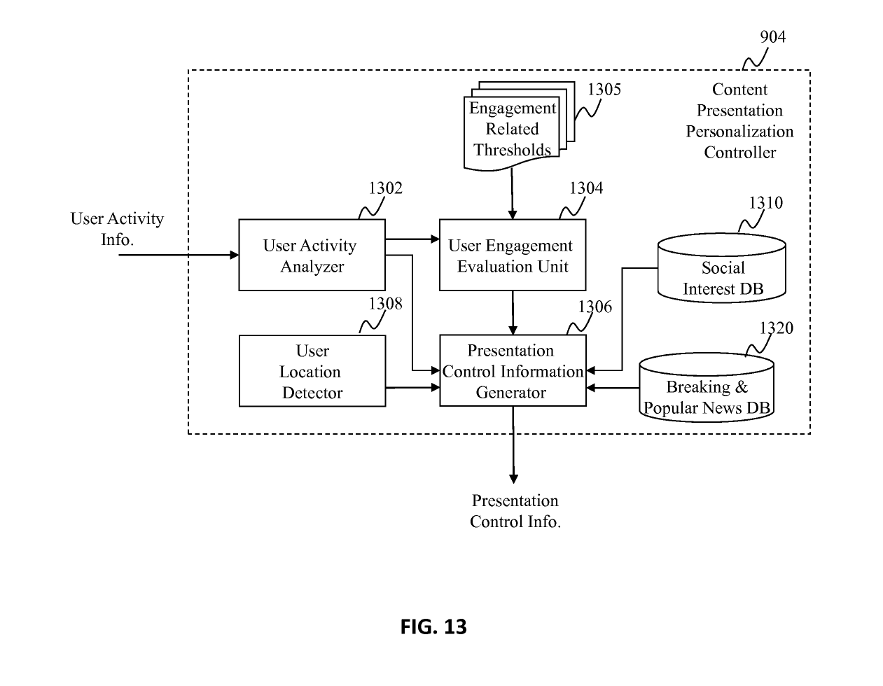

FIG. 13 illustrates an exemplary diagram of a content presentation personalization controller 904 in a page personalization engine, e.g. the page personalization engine 740 in FIG. 9, according to an embodiment of the present teaching. The content presentation personalization controller 904 in this example includes a user activity analyzer 1302, a user engagement evaluation unit 1304, a presentation control information generator 1306, and a user location detector 1308. The user activity analyzer 1302 in this example receives and analyzes information about user activity from a user. Based on the analyzing, the user activity analyzer 1302 may determine that the user has sent a request for a web page. For example, after a user clicks on a link or reference to a web page, a request for the web page is received and determined at the user activity analyzer 1302. The user activity analyzer 1302 may also determine whether the user has accessed a first content item related to a topic. For example, if the user has accessed a first content item referred from the web page before clicks on the link to come back to the page, the user activity analyzer 1302 can pass the information to the user engagement evaluation unit 1304 for evaluating user engagement regarding the access to the first content item and to the presentation control information generator 1306 for generating presentation control information.

The user engagement evaluation unit 1304 in this example evaluates a user's engagement regarding some content. For example, the user engagement evaluation unit 1304 may evaluate how engaged the user is when she accessed the first content item related to a first topic. The evaluation may be based on one or more engagement related thresholds 1305 stored in the content presentation personalization controller 904. In one example, when a user's engagement level regarding a topic is higher than a first engagement related threshold, the user engagement evaluation unit 1304 may inform the presentation control information generator 1306 to generate presentation control information based on the engagement only without considering other information like social interest. This can save processing time and energy because the engagement level regarding the topic from the user is high enough to make a decision to explore the topic. In another example, when a user's engagement level regarding a topic is lower than a second engagement related threshold, the user engagement evaluation unit 1304 may inform the presentation control information generator 1306 to generate presentation control information based on the engagement only without considering other information like social interest. This can save processing time and energy because the engagement level regarding the topic from the user is low enough to make a decision not to explore the topic. In yet another example, when the user's engagement level regarding a topic is between the first and second engagement related thresholds, the user engagement evaluation unit 1304 may inform the presentation control information generator 1306 to generate presentation control information based on the engagement as well as other information like social interest. This is because the engagement level regarding the topic from the user is neither high nor low enough to make a decision about topic exploration based on the engagement alone.

The presentation control information generator 1306 in this example obtains information about social interest from a social interest database 1310 in the content presentation personalization controller 904, information about breaking/popular news from a breaking and popular news database 1320 in the content presentation personalization controller 904, and information about the user's location from the user location detector 1308. The user location detector 1308 in this example detects the user's location, e.g. based on information sent by a device being used by the user to connect to the network 720. The user location detector 1308 may send information related to the user's location to the presentation control information generator 1306.

The social interest obtained by the presentation control information generator 1306 may be related to a topic of the first content item that has been accessed by the user. For example, if the topic of the first content item is “sports”, social interest on “sports” can be retrieved by the presentation control information generator 1306 from the social interest database 1310. The breaking/popular news obtained by the presentation control information generator 1306 may also be related to the topic of the first content item that has been accessed by the user. For example, if the topic of the first content item is “finance”, breaking/popular news related to “finance” can be retrieved by the presentation control information generator 1306 from the breaking and popular news database 1320. The topic of the first content item can be derived based on information about the analyzed user activities sent by the user activity analyzer 1302. The presentation control information generator 1306 may generate presentation control information based on at least one of: user engagement level sent by the user engagement evaluation unit 1304, user location information sent by the user location detector 1308, social interest retrieved from the social interest database 1310, and breaking/popular news retrieved from the breaking and popular news database 1320.

In one embodiment, the user activity analyzer 1302 determines that the user has not accessed any content related to a topic before clicks on a reference to a web page, e.g. when a new user first log into a website. In this embodiment, the user activity analyzer 1302 inform the presentation control information generator 1306 about the user's situation and state. The presentation control information generator 1306 may generate presentation control information based on the user's demographic information input by the user during registration or based on most popular and hot topics from the social interest at that moment.

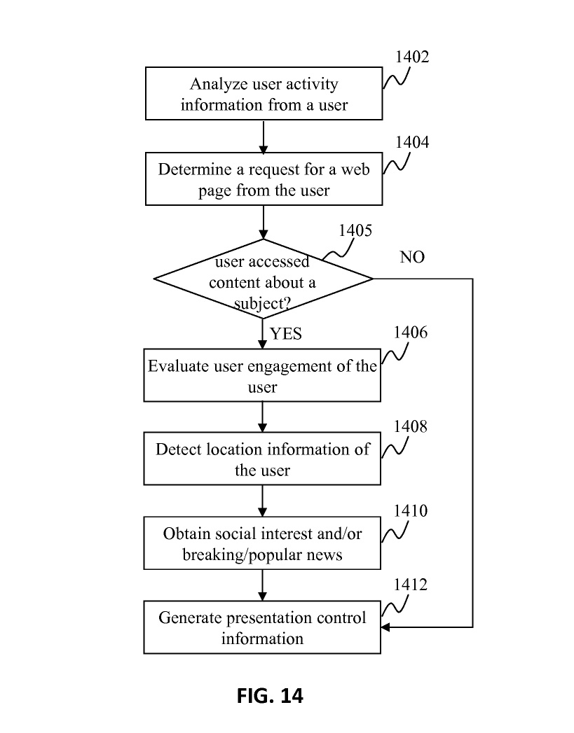

FIG. 14 is a flowchart of an exemplary process performed by a content item presentation personalization controller, e.g. the content presentation personalization controller 904 in FIG. 13, according to an embodiment of the present teaching. Starting at 1402, user activity information about a user is received and analyzed. At 1404, a request for a web page from the user is determined, e.g. based on user activity information.

At 1405, whether the user has accessed some content about a subject is determined. If so, engagement level of the user regarding the content is evaluated at 1406 and the process moves on to 1408. If not, the process goes directly to 1412, where presentation control information is generated, e.g. based on the user's demographic information.

At 1408, location information of the user is detected. At 1410, social interest and/or breaking/popular news related to the subject are obtained. Then at 1412, presentation control information is generated based on at least one of: the user's engagement level, the location information of the user, social interest about the subject, and breaking/popular news related to the subject. In accordance with various embodiments, the presentation control information may also comprise: user information like user identification (ID) and content information related to the content the user has accessed.

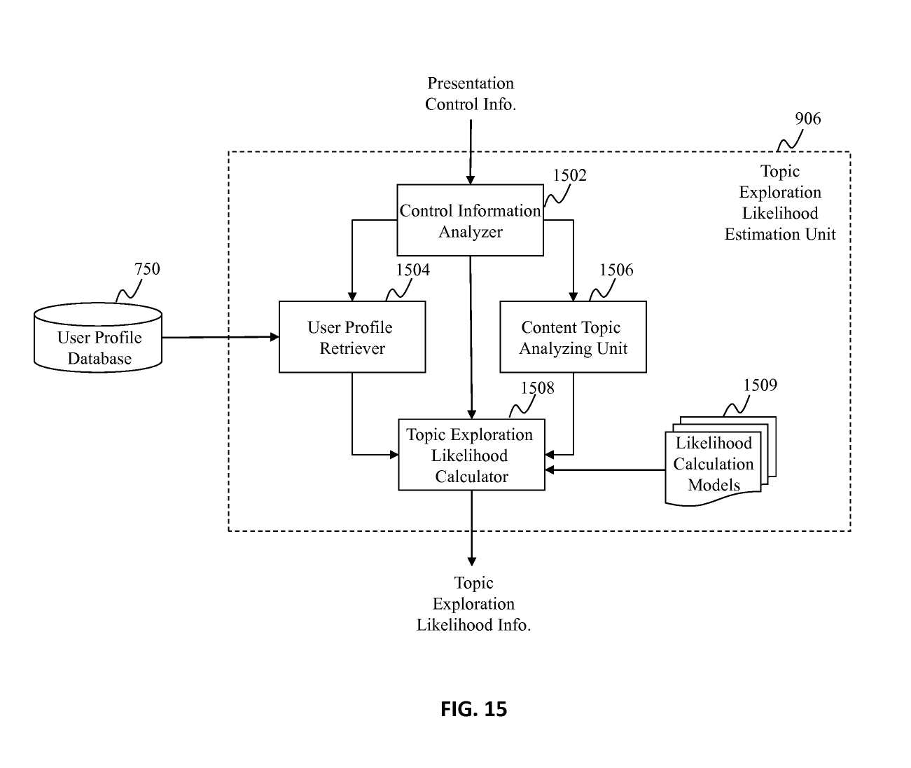

FIG. 15 illustrates an exemplary diagram of a topic exploration likelihood estimation unit 906 in a page personalization engine, e.g. the page personalization engine 740 in FIG. 9, according to an embodiment of the present teaching. The topic exploration likelihood estimation unit 906 in this example includes a control information analyzer 1502, a user profile retriever 1504, a content topic analyzing unit 1506, and a topic exploration likelihood calculator 1508. The control information analyzer 1502 in this example receives and analyzes presentation control information sent by the content presentation personalization controller 904. Based on the analyzing, the control information analyzer 1502 may send user information, e.g. user ID, to the user profile retriever 1504 for retrieving a user profile, send content information to the content topic analyzing unit 1506 for analyzing a topic of the content accessed by the user, and send other information (e.g. engagement level, location information, social interest, breaking news, etc.) from the presentation control information to the topic exploration likelihood calculator 1508 for calculating a topic exploration likelihood.

The user profile retriever 1504 in this example retrieves and analyzes a user profile of the user, e.g. based on the user ID sent by the control information analyzer 1502. Based on the analysis at the user profile retriever 1504, the user profile retriever 1504 may estimate or determine topics of the user's interest and send these topics to the topic exploration likelihood calculator 1508. The content topic analyzing unit 1506 in this example analyzes topic of the content accessed by the user. For example, if the user has accessed a first content item, and the control information analyzer 1502 has passed the information about the first content item, the user profile retriever 1504 may determine one or more topics related to the first content item and send the topics to the topic exploration likelihood calculator 1508.

The topic exploration likelihood calculator 1508 in this example receives topics of the user's interest from the user profile retriever 1504, topics related to the first content item accessed by the user from the content topic analyzing unit 1506, and presentation control information from the control information analyzer 1502. The topic exploration likelihood calculator 1508 may select one of a plurality of likelihood calculation models 1509 stored in the topic exploration likelihood estimation unit 906, based on the received information. For example, if the first content item is related to a hot topic drawing many social interests and there are many breaking news related to the topic, a model having more weights on the social interests and breaking news can be selected so that unless the user has shown explicit dislikes regarding the topic, more breaking news and more social interests lead to higher likelihood for the user to follow additional content items about the topic. For example, if the user has shown high engagement during her access to the first content item, e.g. by activities like frequent and active clicks, scrolls, zooms in, etc., another model may be selected so that even if the topic is not popular among social interests, the user is very likely to follow references to additional content items about the topic due to her engagement regarding the first content item related to the topic. In another example, a model can be selected based on the user's location. If the user is detected to be located in Hawaii, for example, after the user accessed a first content item related to Hawaii, there is a high likelihood for the user to follow additional references to additional content items related to Hawaii. In yet another example, if the user is interested in music based on the user profile analyzed at the user profile retriever 1504, a model may be selected to consider whether the first content item is related to music. If so, there is a high likelihood for the user to follow additional references to additional content items related to music. Thus, the topic exploration likelihood calculator 1508 may select a likelihood calculation model 1509 for the user, and calculate a topic exploration likelihood based on the selected model.

Calculating the likelihood at the topic exploration likelihood calculator 1508 may be carried out by using a supervised learning model. A supervised learning model attempts to generalize a function or mapping from inputs to outputs which can then be used speculatively to generate an output for previously unseen inputs. A supervised learning model is trained on labeled examples, i.e., input where the desired output is known. Each labeled example may be a pair consisting of an input object (typically a vector) and a desired output value (also called the supervisory signal).

In the context of this disclosure, it is possible to train the supervised learning model using labeled examples including characteristics of this particular user who accessed the topic and characteristics of the first content item as the input and whether this particular user is interested in additional content items on the same subject of the first content item. Sometimes, characteristics of this particular user may not be available or may not be detailed. For example, certain characteristics of this particular user such gender, age, income, spending habits, and history of content access (e.g., past reading behavior, past exploration pattern for a subject similar to the subject of the first content item, session time) may be unknown. The supervised learning model may be trained using labeled examples including only the available characteristics (e.g., the coarse location of this particular user because it is almost always determinable from the IP address, phone number, access to mobile access point (e.g., Wi-Fi hotspot, mobile network base station)), or using labeled examples including characteristics of other users similar to this particular user (e.g., in terms of having near coarse location with this particular user, having the same gender, similar age, similar income). The supervised learning model may be probabilistic—it infers a probability of an output (e.g., the probability this particular user is interested in the additional content items) conditioned on an input (e.g., the characteristics of this particular user and the characteristics of the first content item).

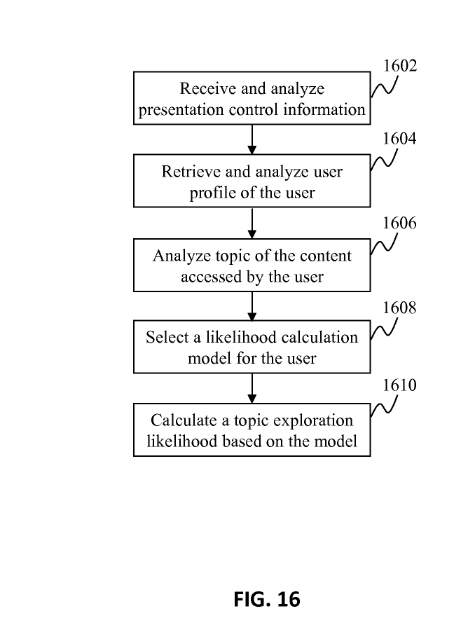

FIG. 16 is a flowchart of an exemplary process performed by a topic exploration likelihood estimation unit, e.g. the topic exploration likelihood estimation unit 906 in FIG. 15, according to an embodiment of the present teaching. Starting at 1602, presentation control information is received and analyzed. At 1604, a user profile of the user is retrieved and analyzed. At 1606, a topic of the content accessed by the user is analyzed and determined. At 1608, a likelihood calculation model is selected for the user. At 1610, a topic exploration likelihood is calculated based on the selected likelihood calculation model.

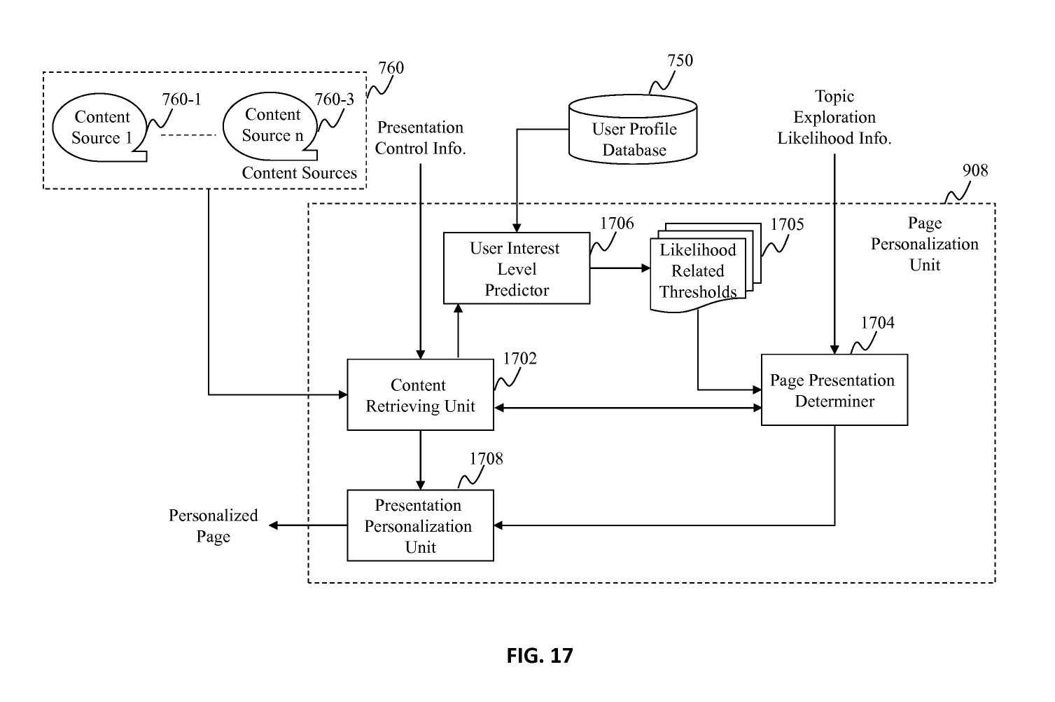

FIG. 17 illustrates an exemplary diagram of a page personalization unit 908 in a page personalization engine, e.g. the page personalization engine 740 in FIG. 9, according to an embodiment of the present teaching. The page personalization unit 908 in this example includes a content retrieving unit 1702, a page presentation determiner 1704, a user interest level predictor 1706, and a presentation personalization unit 1708.

The content retrieving unit 1702 in this example receives presentation control information from the content presentation personalization controller 904. The content retrieving unit 1702 may analyze the presentation control information to determine a request for a web page from a user. The content retrieving unit 1702 can retrieve content from the content sources 760 to be presented in the web page requested by the user. The content retrieving unit 1702 may also determine whether the user has accessed some content about a subject or topic. For example, if the content retrieving unit 1702 determines the user has accessed a first content item related to a topic, the content retrieving unit 1702 may pass this information to the page presentation determiner 1704 to determine a way to present the web page and pass the information to the user interest level predictor 1706 to predict the user's interest level on the content other than the first item in the web page. In one embodiment, if the user has not accessed any content item yet, the content retrieving unit 1702 may pass the content from retrieved from the content sources 760 to the presentation personalization unit 1708 for generating the page requested by the user. In another embodiment, if the user has accessed content related to a topic and the page presentation determiner 1704 determines to present additional content items related to the topic, the content retrieving unit 1702 may retrieve the additional content items from the content sources 760 and send them to the presentation personalization unit 1708 to generate a personalized page.

The page presentation determiner 1704 in this example receives the topic exploration likelihood information from the topic exploration likelihood estimation unit 906 and determines a way or a mode to present the web page, based on the received topic exploration likelihood information. The page presentation determiner 1704 may compare the topic exploration likelihood with one or more likelihood related thresholds 1705 stored in the page personalization unit 908 to determine how to present the web page. For example, if the topic exploration likelihood with respect to a topic is greater than a likelihood related threshold, additional content items related to the topic are determined to be presented in the web page.

The one or more likelihood related thresholds 1705 may be generated or updated by the user interest level predictor 1706. The user interest level predictor 1706 in this example predicts the user's interest on content items other than the first content item in the page, after the user accessed the first content item. In this case, the user's interest is related to a likelihood for the user to follow the other content items when there is no topic exploration.

The user interest level predictor 1706 may predict this user interest level based on a user profile of the user retrieved from the user profile database 750. For example, if the other content items are related to topics that are not interesting to the user based on his/her user profile, a low user interest level is determined. A low likelihood related threshold may be generated according to the low user interest level. For example, if the other content items are related to topics that are very interesting to the user based on his/her user profile, a high user interest level is determined. A high likelihood related threshold may be generated according to the high user interest level. In one embodiment, the other content items include a second content item related to the same topic as the first content item. Then the user's interest regarding the second content item is predicted by the user interest level predictor 1706 and used to generate a likelihood related threshold 1705.

In some embodiments, a plurality of likelihood related thresholds can be generated based on the user's interest level when there is no topic exploration. For example, a first likelihood related threshold is 0.8 so that the topic exploration likelihood has to be higher than 0.8 to allow additional content items related to the topic presented in the page in an expanded form. A second likelihood related threshold is 0.4 so that: if the topic exploration likelihood is lower than 0.4, no additional content item related to the topic is presented in any form; if the topic exploration likelihood is higher than 0.4 but lower than 0.8, additional content items related to the topic may be presented in the page in a condensed form, as shown in FIG. 5. For example, if the topic exploration likelihood regarding a topic related to the first content item is 0.7, the page presentation determiner 1704 determines to present additional content items related to the topic in the web page, but in a condensed form. The page presentation determiner 1704 then informs the content retrieving unit 1702 to retrieve the additional content items from the content sources 760 and informs the presentation personalization unit 1708 to generate a personalized web page to include the additional content items in a condensed form.

The presentation personalization unit 1708 in this example receives content items sent by the content retrieving unit 1702 and page presentation information from the page presentation determiner 1704, and generates a web page. The web page may have a personalized presentation based on the page presentation mode determined by the page presentation determiner 1704. For example, as shown in FIG. 4, additional articles about subject A are presented after the requesting user accessed an article about the subject A; while the additional articles about subject A may not be presented if the requesting user has not accessed an article about the subject A or if the requesting user did not show a good engagement level regarding the accessed article. As describe before, these page presentation modes can be determined by the page presentation determiner 1704 based on a topic exploration likelihood regarding the topic and one or more likelihood related thresholds 1705. The presentation personalization unit 1708 may send the generated web page, which may be personalized, to the user as a response to the page request.

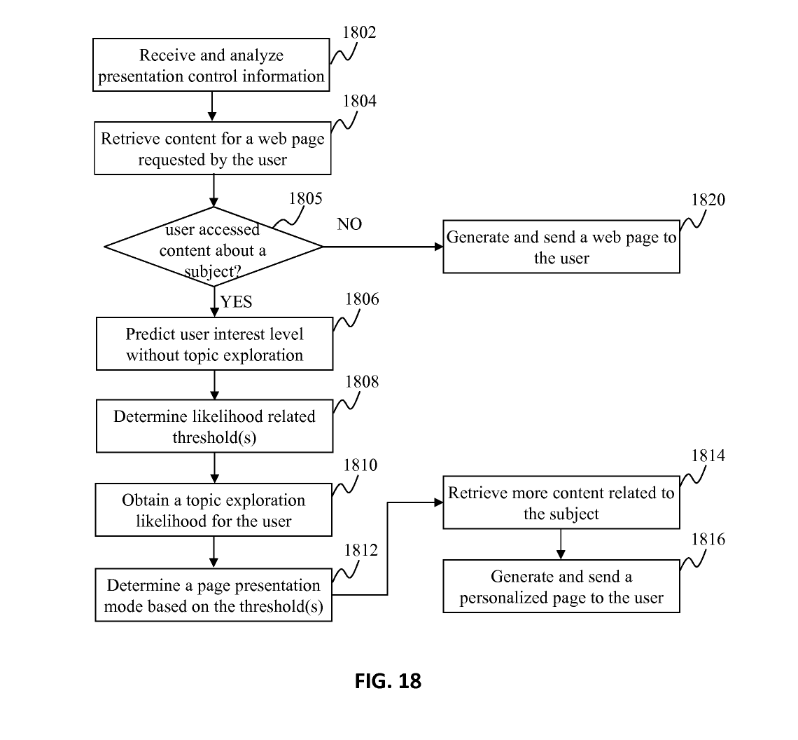

FIG. 18 is a flowchart of an exemplary process performed by a page personalization unit, e.g. the page personalization unit 908 in FIG. 17, according to an embodiment of the present teaching. Starting at 1802, presentation control information is received and analyzed. At 1804, content for a web page requested by the user is retrieved.

At 1805, it is determined whether the user has accessed content about a subject. If so, at 1806, the user's interest level regarding other content items in the page is predicted when there is no topic exploration regarding the subject, and the process moves on to 1808. Otherwise, at 1820, a web page is generated and sent to the user. This web page may not be personalized or may be personalized based on the user's demographic information.

At 1808, one or more likelihood related thresholds are determined. At 1810, a topic exploration likelihood regarding the subject is obtained for the user. At 1812, a page presentation mode is determined based on the topic exploration likelihood and the one or more likelihood related thresholds. At 1814, more content related to the subject is retrieved. As described above, the step at 1814 may not happen if the topic exploration likelihood is lower than some threshold. At 1816, a personalized page is generated based on the page presentation mode and sent to the user.

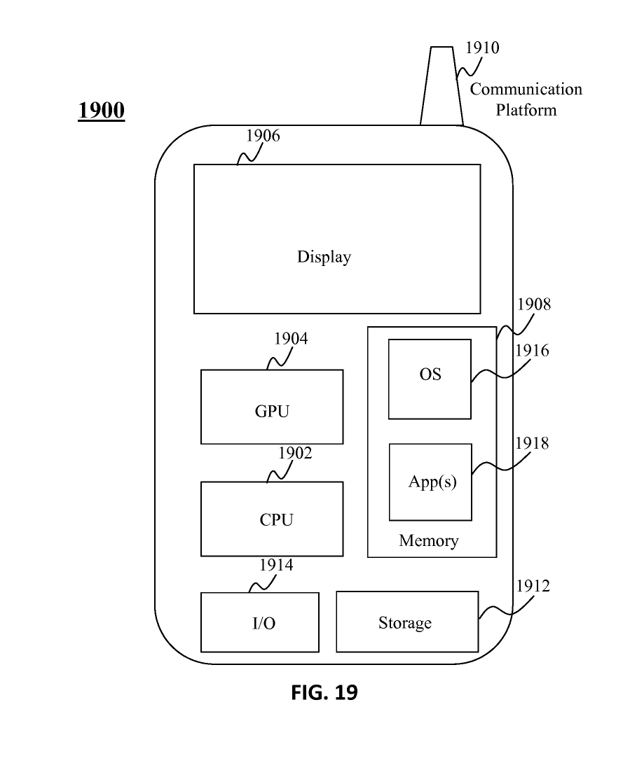

FIG. 19 depicts a general mobile device architecture on which the present teaching can be implemented. In this example, a device of the user 710 is a mobile device 1900, including but is not limited to, a smart phone, a tablet, a music player, a handled gaming console, a GPS receiver. The mobile device 1900 in this example includes one or more central processing units (CPUs) 1902, one or more graphic processing units (GPUs) 1904, a display 1906, a memory 1908, a communication platform 1910, such as a wireless communication module, storage 1912, and one or more input/output (I/O) devices 1919. Any other suitable component, such as but not limited to a system bus or a controller (not shown), may also be included in the mobile device 1900. As shown in FIG. 19, a mobile operating system 1916, e.g., iOS, Android, Windows Phone, etc., and one or more applications 1918 may be loaded into the memory 1908 from the storage 1912 in order to be executed by the CPU 1902. The applications 1918 may include a web browser or any other suitable mobile search apps. Execution of the applications 1918 may cause the mobile device 1900 to perform some processing as described before. For example, the display of content items and search results is made by the GPU 1904 in conjunction with the display 1906. User inputs are received via the I/O devices 1914 and sent to the publisher 730 via the communication platform 1910.

To implement the present teaching, computer hardware platforms may be used as the hardware platform(s) for one or more of the elements described herein. The hardware elements, operating systems, and programming languages of such computers are conventional in nature, and it is presumed that those skilled in the art are adequately familiar therewith to adapt those technologies to implement the processing essentially as described herein. A computer with user interface elements may be used to implement a personal computer (PC) or other type of work station or terminal device, although a computer may also act as a server if appropriately programmed. It is believed that those skilled in the art are familiar with the structure, programming, and general operation of such computer equipment and as a result the drawings should be self-explanatory.

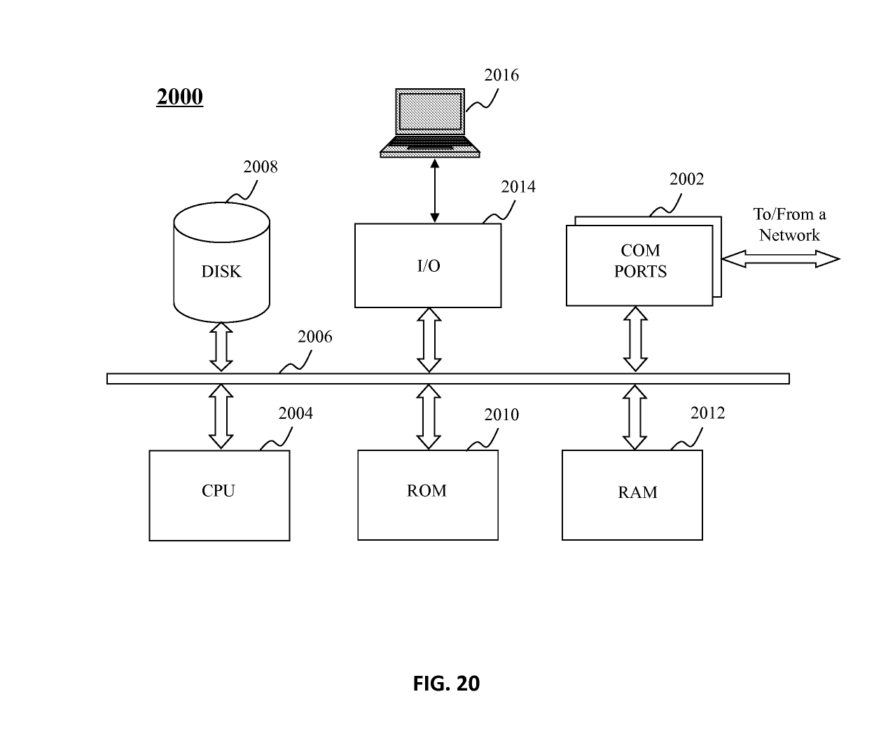

FIG. 20 depicts a general computer architecture on which the present teaching can be implemented and has a functional block diagram illustration of a computer hardware platform that includes user interface elements. The computer may be a general-purpose computer or a special purpose computer. This computer 2000 can be used to implement any components of the personalized content presentation architecture as described herein. Different components of the system, e.g., as depicted in FIGS. 7 and 8, can all be implemented on one or more computers such as computer 2000, via its hardware, software program, firmware, or a combination thereof. Although only one such computer is shown, for convenience, the computer functions relating to personalized content presentation may be implemented in a distributed fashion on a number of similar platforms, to distribute the processing load.

The computer 2000, for example, includes COM ports 2002 connected to and from a network connected thereto to facilitate data communications. The computer 2000 also includes a CPU 2004, in the form of one or more processors, for executing program instructions. The exemplary computer platform includes an internal communication bus 2006, program storage and data storage of different forms, e.g., disk 2008, read only memory (ROM) 2010, or random access memory (RAM) 2012, for various data files to be processed and/or communicated by the computer, as well as possibly program instructions to be executed by the CPU 2004. The computer 2000 also includes an I/O component 2014, supporting input/output flows between the computer and other components therein such as user interface elements 2016. The computer 2000 may also receive programming and data via network communications.

Hence, aspects of the method of personalized content presentation, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution—e.g., an installation on an existing server. In addition, the dynamic relation/event detector and its components as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method, implemented on a machine having at least one processor, storage, and a communication platform connected to a network for personalized presentation of content, comprising:
providing, to a user, a first reference to a first content item;
receiving an input from the user indicating that the user is following the first reference to access the first content item;
calculating a likelihood that the user will be interested in an additional content item similar to the first content item; and
providing, to the user, an actionable representation of the additional content item, wherein
the actionable representation comprises an additional reference to the additional content item, and
the actionable representation is presented in a manner determined based on the calculated likelihood.

2. The method of claim 1, wherein the likelihood is calculated based on a user profile of the user.

3. The method of claim 1, wherein the first content item is characterized based on a topic.

4. The method of claim 1, further comprising providing, to the user, at least a second reference to a second content item.

5. The method of claim 4, wherein the actionable representation comprises a group of content items which can be presented in an expanded form or a condensed form.

6. The method of claim 5, wherein:
the group is presented to the user in an expanded form if the likelihood is above a threshold related to a probability that the user will follow the second reference; and
the group is presented to the user in a condensed form if the likelihood is not above a threshold related to a probability that the user will follow the second reference.

7. The method of claim 1, wherein the actionable representation is presented immediately following the first reference.

8. The method of claim 1, wherein the actionable representation comprises a sidebar spanning the first reference and the additional reference.

9. The method of claim 1, wherein the likelihood is calculated based on at least one of:
user engagement of the user with respect to the first content item;
location information of the user;
social interest related to the first content item; and
news related to the first content item.

10. A system, having at least one processor, storage, and a communication platform connected to a network for personalized presentation of content, comprising:
a presentation personalization unit configured to provide, to a user, a first reference to a first content item;
a user activity detection unit configured to receive an input from the user indicating that the user is following the first reference to access the first content item; and
a topic exploration likelihood calculator configured to calculate a likelihood that the user will be interested in an additional content item similar to the first content item, wherein:
the presentation personalization unit is further configured to provide, to the user, an actionable representation of the additional content item,
the actionable representation comprises an additional reference to the additional content item, and
the actionable representation is presented in a manner determined based on the calculated likelihood.

11. The system of claim 10, wherein the likelihood is calculated based on a user profile of the user.

12. The system of claim 10, wherein the first content item is characterized based on a topic.

13. The system of claim 10, wherein the presentation personalization unit is further configured to provide, to the user, at least a second reference to a second content item.

14. The system of claim 13, wherein the actionable representation comprises a group of content items which can be presented in an expanded form or a condensed form.

15. The system of claim 14, wherein:
the group is presented to the user in an expanded form if the likelihood is above a threshold related to a probability that the user will follow the second reference; and
the group is presented to the user in a condensed form if the likelihood is not above a threshold related to a probability that the user will follow the second reference.

16. The system of claim 10, wherein the actionable representation is presented immediately following the first reference.

17. The system of claim 10, wherein the actionable representation comprises a sidebar spanning the first reference and the additional reference.

18. A machine-readable tangible and non-transitory medium having information recorded thereon for personalized presentation of content, wherein the information, when read by the machine, causes the machine to perform the following:
providing, to a user, a first reference to a first content item;
receiving an input from the user indicating that the user is following the first reference to access the first content item;
calculating a likelihood that the user will be interested in an additional content item similar to the first content item; and
providing, to the user, an actionable representation of the additional content item, wherein
the actionable representation comprises an additional reference to the additional content item, and
the actionable representation is presented in a manner determined based on the calculated likelihood.

19. The medium of claim 18, where the information, when read by the machine, further causes the machine to provide, to the user, at least a second reference to a second content item.

20. The medium of claim 19, wherein the actionable representation comprises a group of content items which can be presented in an expanded form or a condensed form.

21. The medium of claim 20, wherein:
the group is presented to the user in an expanded form if the likelihood is above a threshold related to a probability that the user will follow the second reference; and
the group is presented to the user in a condensed form if the likelihood is not above a threshold related to a probability that the user will follow the second reference.
